(19) United States
(12) Patent Application Publication
(10) Pub. No.: US 2026/0170599 A1
(43) Pub. Date: Jun. 18, 2026

(54) PIXEL COVERAGE BASED BINNING

(71) Applicant: QUALCOMM Incorporated, San Diego, CA (US)

(72) Inventors: Sanjeevi S, Bangalore (IN); Nawneet KUMAR, Bangalore (IN); Avinash JAIN, Ghaziabad (IN); Rakshit JOSHI, Almora (IN); Vignesh BASKARAN, Bangalore (IN)

(21) Appl. No.: 18/981,294

(22) Filed: Dec. 13, 2024

(51) Int. Cl. G06T 1/60

(52) U.S. Cl. CPC G06T 1/60

(57) ABSTRACT

This disclosure provides systems, devices, apparatus, and methods, including computer programs encoded on storage media, for pixel coverage based binning. A graphics processor may be configured to determine, in a visibility-pass of image data for a set of bins, an indication of bin coverage for each bin in the set of bins. The graphics processor may be configured to render a portion of the image data associated with a bin in the set of bins based on the indication of bin coverage for the bin and a coverage threshold The graphics processor may also be configured to determine to refrain from loading image data to a graphics memory and from storing image data to a system memory in association with the rendering.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for graphics processing may utilize hardware binning, but may not address issues that arise for overhead from associated load and store operations in binning, particularly when pixel coverage for bins is relatively small. There is a need for improved techniques for hardware binning such that overhead may be reduced for bins having low pixel coverage to improve processing and memory efficiency.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: determine, in association with a visibility-pass of image data for a set of bins, an indication of bin coverage for each bin in the set of bins; and rendering a portion of the image data associated with a subset of bins in the set of bins in accordance with respective indications of bin coverage for each of the subset of bins that fail to meet a coverage threshold.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 illustrates an example of hardware binning.

FIG. 5 illustrates an example of render-passes for pixel coverage based binning in accordance with one or more techniques of this disclosure.

FIG. 6 illustrates an example of a visibility-pass for pixel coverage based binning in accordance with one or more techniques of this disclosure.

FIG. 7 illustrates an example of a visibility-pass and render-passes for pixel coverage based binning with a single render-pass over low coverage bins in accordance with one or more techniques of this disclosure.

FIG. 8 is a call flow diagram illustrating example communications between a CPU and a GPU in accordance with one or more techniques of this disclosure.

FIG. 9 is a flowchart of an example method of graphics processing in accordance with one or more techniques of this disclosure.

FIG. 10 is a flowchart of an example method of graphics processing in accordance with one or more techniques of this disclosure

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, the term “workload” may refer to a program or application that is processed by a processor, e.g., a GPU, such as a gaming application, productivity applications, graphics applications, workbench analysis applications, etc. As used herein, the term “bin” may refer to one of multiple elements of a logical division of image data for a render target. As used herein, the term “render target” may refer to a component for which renders of image data from bins, e.g., where a render may be a result of a rendering that was performed on image data, are sent, such as a frame buffer and/or the like. As used herein, the term “bin coverage” may refer to an amount, a percentage, etc., of image data (e.g., as pixels) that is visible for a given bin. As used herein, the term “visibility-pass” may refer to a set of operations, performed once per workload, for determinations of visibility for draws/primitives associated with workload image data. As used herein, the term “visibility stream” may refer to a set of binary data (or other type of a data structure) in which bits correspond to respective draws/primitives and values of which are indicative of visibility. As used herein, the term “render-pass” may refer to a set of operations, performed on a per-bin basis, by which visible draws/primitives are rendered to the render target. As used herein, the term “bin scissor” may refer to a process in which visible draws/primitives of a bin rendered for a specific bin region with renders outside of the region being clipped. As used herein, the term “array of bin scissors” may refer to a set of bin scissors for specific bin regions that may be rendered together in a single render without any renders outside of the regions. As used herein, the term “dead draw” may refer to a draw operation associated with a primitive that is not visible in a scene of image data for a workload.

GPUs may render graphics/image data in various ways for workloads. In one example, a GPU may utilize a direct render technique by which pixels may be rendered to a render target stored in a system memory (SYSMEM). such as a video memory. In another example, a GPU may utilize hardware-based binning to render image data to render targets which are loaded into a graphics memory (GMEM), such a dedicated memory for the GPU. In the context of hardware-based binning, the render target may be divided into multiple bins, which may be configured so that each individual bin may be configured to fit into the graphics memory. In some examples, hardware-based binning may include operations such as a visibility-pass (e.g., once per workload) and a set of render-passes (e.g., for each bin). Each render-pass may include a load of a bin into the graphics memory, a render to the render target in the graphics memory, and a storing of the bin, after rendering, from the graphics memory to a system memory. However, issues may arise from overhead from associated load operations for graphics memory from system memory (e.g., unresolve) and store operations to system memory from graphics memory (e.g., resolve) in binning, which consume graphics processing time. When pixel coverage for bins is relatively small, binning operations are still performed, consuming time and resources, even though very little visible image data is present during such operations, yet selectively determining direct renderings to system memory is not currently available for hardware binning—instead, hardware binning suffers from the overhead of load (unresolve)/store (resolve) operation time. There is a need for improved techniques for hardware binning such that overhead may be reduced for bins having low pixel coverage to improve processing and memory efficiency.

Aspects herein for pixel coverage based binning enable utilization of image data rendering to the system memory. For example, if the pixel coverage of a bin is small, e.g., based on a threshold condition, aspects provide for directly rendering to the system memory to benefit performance and resource utilization, e.g., considering the additional overhead of resolve and unresolve time in typical hardware-based binning. In cases where a small part of a given bin is covered, to overcome the load/store overhead, aspects enable pixel coverage based binning. In the visibility-pass, a rasterizer may determine/calculate the bin coverage for all the bins. At the end of the visibility-pass, a command processor may access the bin coverage data from the rasterizer and determine which bins have less coverage, e.g., which bins fail to meet a coverage threshold, such as but without limitation, an amount or a number of pixels for pixel coverage for a given bin (e.g., for visible image data), a percentage of a bin having pixel coverage for visible image data (e.g., 10%, 20%, etc.), and/or the like. The command processor may then mark/identify the bins with low pixel coverage, and during the render-pass portion of binning, the command processor may can skip, or refrain from performing, the load/store operations of these bins and render them to the system memory instead of the graphics memory. Aspects also provide for the command processor to combine the visibility stream of the bins which are marked (e.g., the low coverage bins) and execute the render-pass once for all the marked bins using a bin scissor array (e.g., a bin scissor for all the marked bins as an array of bin scissors) rather than performing individual renders for the bins. Accordingly, aspects provide for pixel coverage based binning in which bins having pixel coverage that is low (e.g., based on a coverage threshold) may be rendered directly to system memory, rather than graphics memory, which enables the load/store operations associated with typical rendering to be skipped, thus improving overall GPU and memory efficiency and performance (e.g., reducing execution times, memory operations, etc.).

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

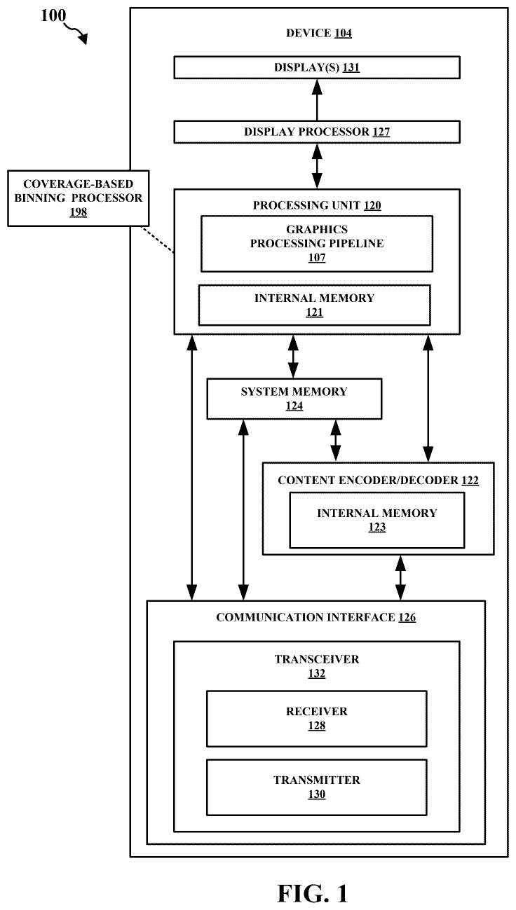

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an coverage-based binning processor 198 configured to determine, in a visibility-pass of image data for a set of bins, an indication of bin coverage for each bin in the set of bins and to render a portion of the image data associated a bin in the set of bins based on the indication of bin coverage for the bin and a coverage threshold. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

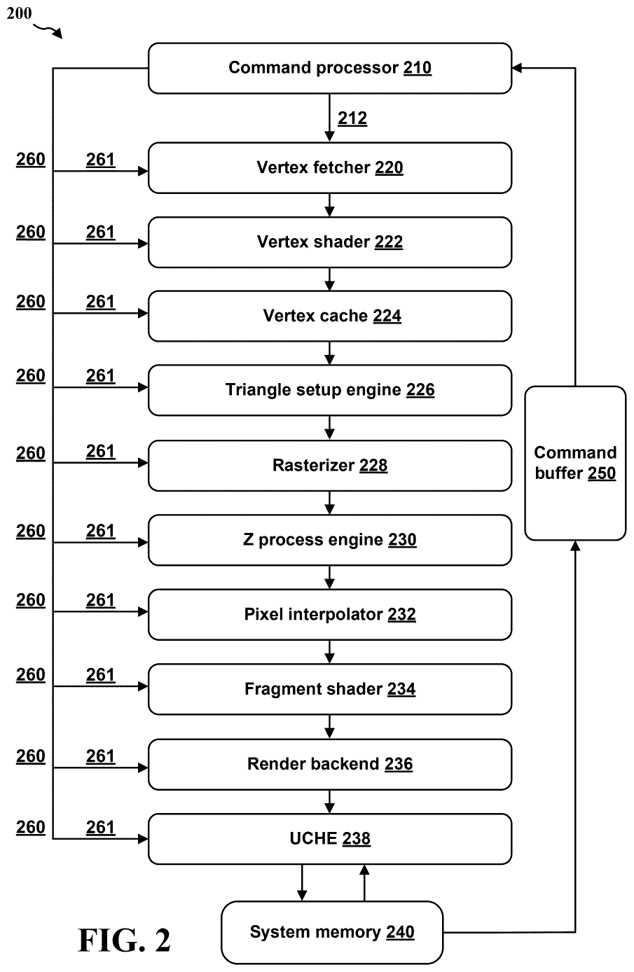

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility-pass and a rendering or bin-rendering pass. During a visibility-pass, a GPU can input a rendering workload, record the positions of the primitives or triangles, and then determine which primitives or triangles fall into which bin or area. In some aspects of a visibility-pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility-pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

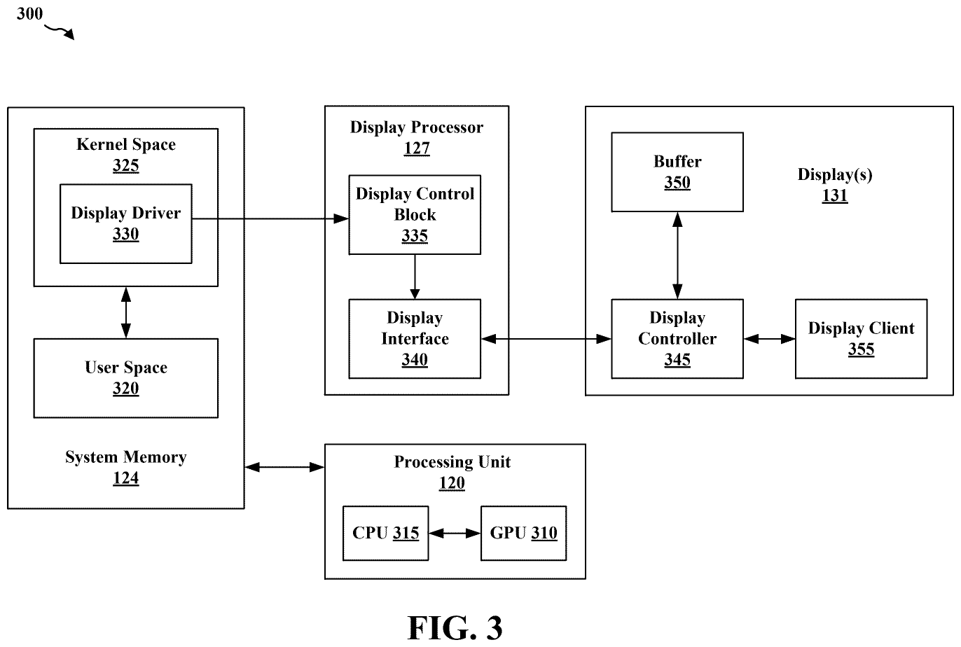

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

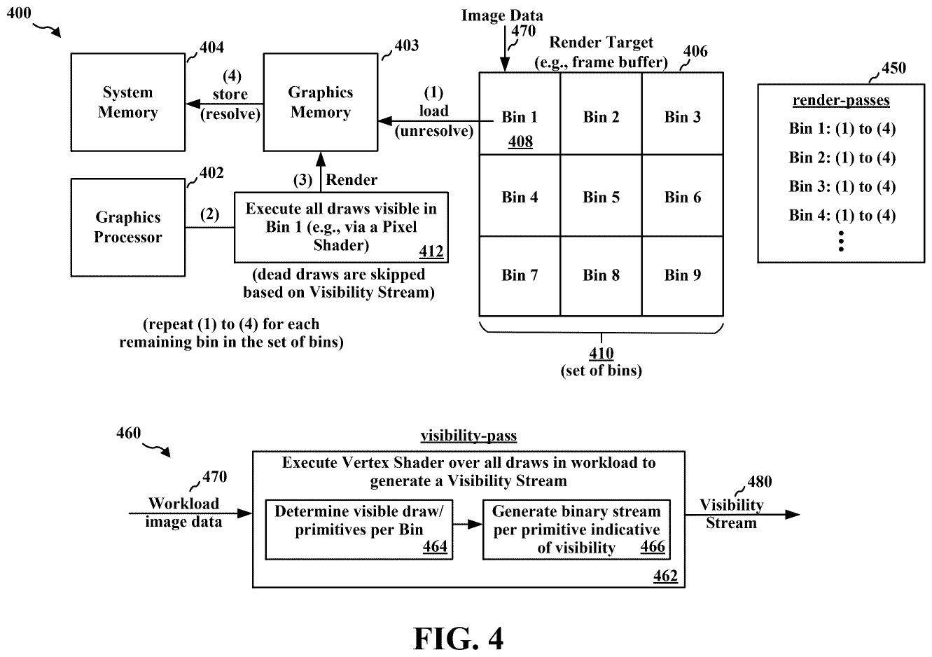

FIG. 4 illustrates an example diagram 400 of hardware binning. In some examples, a graphics processor 402, e.g., a GPU, may perform hardware binning that includes a visibility-pass 460 and render-passes 450 for each bin of a set of bins 410 (e.g., including a bin 1 408) associated with image data 470 of a workload for a render target 406 (e.g., a frame buffer). The render target 406 may be divided into the set of bins 410 such that each bin (e.g., the bin 1 408, etc.) may fit into a graphics memory 403. For hardware binning, pixels of the image data 470 may be rendered to the render target 406, which may be loaded into the graphics memory 403.

For the visibility-pass 460, which may be performed once per workload, a vertex shader may be run/executed (at 462) for all the draws in the workload to generate (at 466) a visibility stream 480. The visibility stream 480 may indicate/determine (at 464) the draws/primitives which are visible in each bin of the set of bins 410. For example, the visibility stream 480 may be generated (at 466) as a binary stream of ones (1's) and zeroes (0's) per bin of the set of bins 410 to indicate which draw/primitive(s) is/are visible in a given bin. In the visibility stream 480, each primitive in a scene may have one bit per bin to indicate if that primitive is visible or not.

In each of the render-passes 450, the first bin (e.g., the bin 1 408) of the render target 406 may be loaded (e.g., at (1)) into the graphics memory 403. The graphics processor 402 may execute (at 412 (e.g., at (2)) all draws visible in the bin 1 408, e.g., via a pixel shader, and may render (e.g., at (3)) the pixel shader output of the visible draws of the bin 1 408 to the render target 406 in the graphics memory 403. After rendering (e.g., at (3)), the bin 1 408 of the render target 406 may be stored (e.g., at (4)) from the graphics memory 403 to a system memory 404. The operations (1), (2), (3), and (4) may be repeated for each other bin in the set of bins 410.

Yet, in hardware binning, load and store operations of the bins consume GPU time and resources. If the pixel coverage of a bin is small, directly rendering the bin to the system memory 404 may be more beneficial considering the additional overhead of the resolve time and the unresolve time shown in diagram 400 for hardware binning. For instance, if a small part/portion/percentage of a given bin is covered, then rendering this bin to the system memory 404 takes less time compared to rendering to the graphics memory 403, plus the unresolve time (e.g., at (1)), plus the resolve time (e.g., at (4)). Simply put, the load and store operations for the bin become overhead with respect to the illustrated configuration in diagram 400.

In contrast to diagram 400, aspects herein provide herein for pixel coverage based binning in which bins having pixel coverage that is low (e.g., based on a coverage threshold) may be rendered directly to system memory, rather than graphics memory, which enables the load/store operations associated with typical rendering to be skipped, thus improving overall GPU and memory efficiency and performance (e.g., reducing execution times, memory operations, etc.).

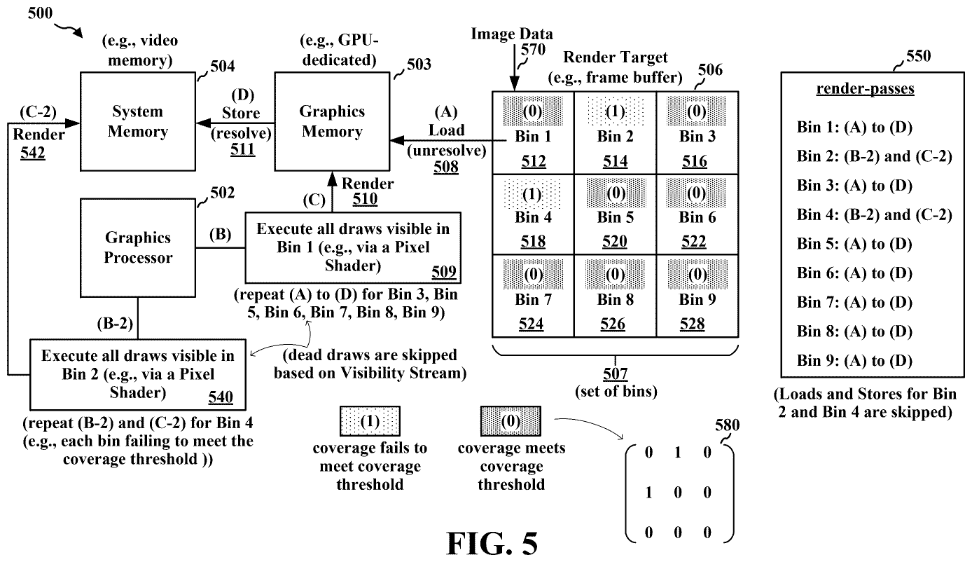

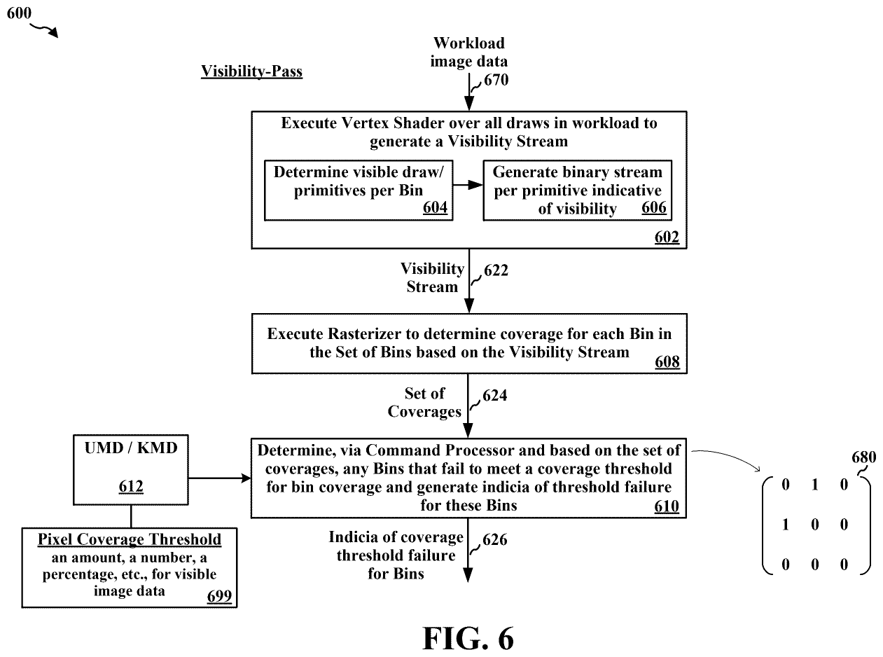

FIG. 5 illustrates an example diagram 500 of render-passes for pixel coverage based binning in accordance with one or more techniques of this disclosure. Diagram 500 shows operations that may be performed by the processing unit 120/the coverage-based binning processor 198 (of FIG. 1). Diagram 500 is illustrated in the context of a graphics processor 502, e.g., a GPU, configured to perform pixel coverage based hardware binning that includes a visibility-pass (not shown for illustrative clarity, but described in further detail below with respect to FIG. 6) and render-passes 550 (e.g., in numerical bin order) for each bin of a set of bins 507 associated with image data 570 of a workload for a render target 506 (e.g., a frame buffer).

The render target 506 may be divided into the set of bins 507 such that each bin thereof may fit into a graphics memory 503. For pixel coverage based binning, pixels of the image data 570 may be rendered to the render target 506, which may be loaded into the graphics memory 503 for bins with pixel coverage meeting a coverage threshold, or which may be rendered to a system memory 504 for bins with pixel coverage not meeting the coverage threshold.

As shown by way of example, the set of bins 507 includes a bin 1 512, a bin 2 514, a bin 3 516, a bin 4 518, a bin 5 520, a bin 6 522, a bin 7 524, a bin 8 526, and a bin 9 528. It should be noted that aspects herein include various numbers of bins for the set of bins 507, and that nine bins are described and shown by way of example for brevity and illustrative clarity. In association with a visibility-pass corresponding to the render-passes 550, bins of the set of bins 507 may be marked or otherwise identified, such as with binary indicators with reference to the p (e.g., 1: pixel coverage not meeting the coverage threshold; 0: pixel coverage meeting the coverage threshold (or vice versa)). The bin 2 514 and the bin 4 518 are shown as being marked/identified (e.g., (1)) for having respective pixel coverages that fail to meet the coverage threshold, while the remaining bins of the set of bins 507 are shown as being marked/identified (e.g., (0)) for having respective pixel coverages that meet the coverage threshold. In aspects, a data structure 580 may be utilized to store/adjust values for each bin that correspond to meeting (e.g., (0))/failing to meet (e.g., (1)) the coverage threshold.

In aspects, the render-passes 550 (e.g., a set of renders or a set of render-passes) may include a render-pass for each bin of the set of bins 507, however, the render-passes for bins (e.g., the bin 2 514 and the bin 4 518) with pixel coverage that fails to meet the coverage threshold may differ, according to aspects herein for pixel coverage based binning, from render-passes for bins with pixel coverage that meets the coverage threshold.

In the context of the bin 1 512, which has pixel coverage that meets the coverage threshold, an associated render-pass of the render-passes 550 for the render target 506 may include a load (e.g., at 508 (A)) of the bin 1 512 into the graphics memory 503. The graphics processor 502 may execute (e.g., at 509 (B)) all draws visible in the bin 1 512 and skip dead draws based on a visibility stream, e.g., via a pixel shader, and may render (e.g., at 510 (C)) the pixel shader output of the visible draws of the bin 1 512 to the render target 506 in the graphics memory 503. After rendering (e.g., at 510 (C)), the bin 1 512 of the render target 506 may be stored (e.g., at 511 (D)) from the graphics memory 503 to the system memory 504. The operations (A), (B), (C), and (D) may be repeated for each other bin in the set of bins 507 having pixel coverage that meets the coverage threshold (e.g., for the bin 3 516, the bin 5 520, the bin 6 522, the bin 7 524, the bin 8 526, and the bin 9 528).

In the context of the bin 2 514, which has pixel coverage that fails to meet the coverage threshold, an associated render-pass of the render-passes 550 for the render target 506 may skip or refrain from performing a load (e.g., at 508 (A)) of the bin 2 514 into the graphics memory 503. Rather, the graphics processor 502 may execute (e.g., at 540 (B−2)) all draws visible in the bin 2 514 and skip dead draws based on a visibility stream, e.g., via a pixel shader, and may render (e.g., at 542 (C−2)) the pixel shader output of the visible draws of the bin 2 514 for the render target 506 in the system memory 504 instead of the graphics memory 503. After rendering (e.g., at 542 (C−2)), the store (e.g., at 511 (D)) from the graphics memory 503 to the system memory 504 may be skipped or refrained from for the bin 2 514 (e.g., based on the direct render to the system memory 504). The operations (B−2) and (C−2) may be repeated for each other bin in the set of bins 507 having pixel coverage that fails to meet the coverage threshold (e.g., the bin 4 518).

While renders of the render-passes 550 are described separately for bins above in the context of pixel coverage and the coverage threshold, aspects provide for the render-passes of the bins of the set of bins 507 to be performed in sequential order based on bin number (e.g., as first to last): the bin 1 512, the bin 2 514, the bin 3 516, the bin 4 518, the bin 5 520, the bin 6 522, the bin 7 524, the bin 8 526, and the bin 9 528.

FIG. 6 illustrates an example diagram 600 of a visibility-pass for pixel coverage based binning in accordance with one or more techniques of this disclosure. Diagram 600 may be an aspect of diagram 500 in FIG. 5. Diagram 600 shows operations that may be performed by the processing unit 120/the coverage-based binning processor 198 (of FIG. 1), which may comprise a graphics processor, e.g., a GPU, configured to perform pixel coverage based hardware binning that includes a visibility-pass, performed prior to a set of render-passes (e.g., the render-passes 550 in FIG. 5), associated with image data 670 of a workload. In aspects, the visibility-pass depicted by way of example in diagram 600 may be performed once for a given workload.

In aspects, the image data 670 may be received, and a vertex shader (e.g., the VS 222 in FIG. 2) may be executed (at 602) over all draws in the workload to generate a visibility stream 622. In aspects, the execution (at 602) may include to determine (at 604) visible draws/primitives per bin of a set of bins, as described herein. Based on the determined visible draws/primitives, a binary stream of data comprising indications, per primitive, of visibility may be generated (at 606) as the visibility stream 622. In aspects, the visibility stream 622 may be any type of a data structure.

Based on the visibility stream 622, a rasterizer (e.g., the RAS 228 in FIG. 2) may be executed (at 608) to determine pixel coverage for each bin in the set of bins as a set of coverages 624. A command processor (e.g., the CP 210 in FIG. 2) may determine (at 610) (e.g., mark/identify) any bins of the set of bins that fail to meet the coverage threshold associated with a pixel coverage threshold 699. The command processor may generate (at 610) an indication of the threshold condition failure 626 for each of the determined/marked/identified bins. In aspects, the coverage threshold associated with the pixel coverage threshold 699 may be an amount or a number of pixels for pixel coverage for a given bin (e.g., for visible image data), a percentage of a bin having pixel coverage for visible image data, and/or the like. In aspects, a data structure 680 may be utilized to store/adjust values for each bin that correspond to meeting (e.g., (0))/failing to meet (e.g., (1)) the coverage threshold.

In aspects, the coverage threshold associated with the pixel coverage threshold 699 may be associated with a driver, e.g., a user-mode driver (UMD) or a kernel-mode driver (KMD), such as the UMD/KMD 612. In aspects, the command processor may obtain an indication of the coverage threshold associated with the pixel coverage threshold 699 via register programming provided by the UMD/KMD 612 for increased flexibility/extensibility of aspects herein for pixel coverage based binning (e.g., enabling choices for render destinations based on pixel coverage for bins rather than a render destination for an entire surface).

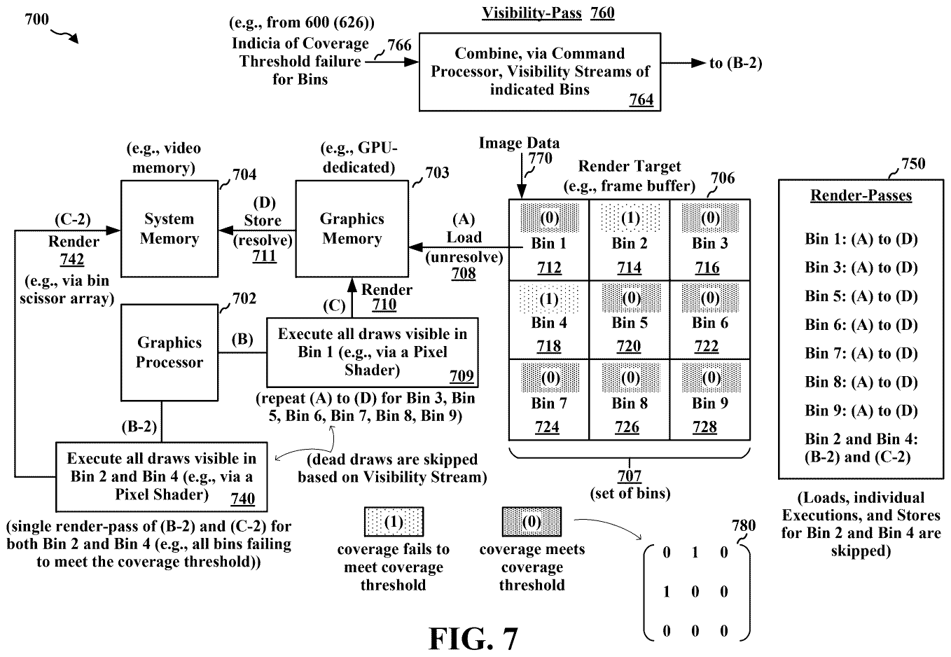

FIG. 7 illustrates an example diagram 700 of a visibility-pass and render-passes for pixel coverage based binning with a single render-pass over low coverage bins in accordance with one or more techniques of this disclosure. Diagram 700 shows operations that may be performed by the processing unit 120/the coverage-based binning processor 198 (of FIG. 1). Diagram 700 is illustrated in the context of a graphics processor 702, e.g., a GPU, configured to perform pixel coverage based hardware binning that includes a visibility-pass 760 (which may be an aspect of the visibility-pass described for FIG. 6) and render-passes 750 associated with image data 770 of a workload for a render target 706 (e.g., a frame buffer). In aspects, render-passes 750 may be performed in numerical bin order for each bin of a set of bins 707 having pixel coverage that meets a coverage threshold (e.g., for the pixel coverage threshold 699 described above for FIG. 6), while bins of the set of bins 707 having pixel coverage that fails to meet the coverage threshold may be rendered together in a single render operation as a final render-pass of the render-passes 750.

The render target 706 may be divided into the set of bins 707 such that each bin thereof may fit into a graphics memory 703. For pixel coverage based binning, pixels of the image data 770 may be rendered to the render target 706, which may be loaded into the graphics memory 703 for bins with pixel coverage meeting a coverage threshold, or which may be rendered to a system memory 704 for bins with pixel coverage not meeting the coverage threshold.

As shown by way of example, the set of bins 707 includes a bin 1 712, a bin 2 714, a bin 3 716, a bin 4 718, a bin 5 720, a bin 6 722, a bin 7 724, a bin 8 726, and a bin 9 728. It should be noted that aspects herein include various numbers of bins for the set of bins 707, and that nine bins are described and shown by way of example for brevity and illustrative clarity. In association with the visibility-pass 760 corresponding to the render-passes 750, bins of the set of bins 707 may be marked or otherwise identified, such as with binary indicators with reference to the p (e.g., 1: pixel coverage not meeting the coverage threshold; 0: pixel coverage meeting the coverage threshold (or vice versa)). The bin 2 714 and the bin 4 718 are shown as being marked/identified (e.g., (1)) for having respective pixel coverages that fail to meet the coverage threshold, while the remaining bins of the set of bins 707 are shown as being marked/identified (e.g., (0)) for having respective pixel coverages that meet the coverage threshold. In aspects, a data structure 780 may be utilized to store/adjust values for each bin that correspond to meeting (e.g., (0))/failing to meet (e.g., (1)) the coverage threshold.

The visibility-pass 760 may be a continuation of diagram 600 in FIG. 6 from which an indication of a threshold condition failure 766 (e.g., the indication of the threshold condition failure 626 in FIG. 6) for each of the bins of the set of bins 707 determined/marked/identified as having a pixel coverage that fails to meet a coverage threshold (e.g., for the pixel coverage threshold 699 described above for FIG. 6). A command processor (e.g., the CP 210 in FIG. 2) may be configured to combine (at 764) the visibility streams (e.g., of the visibility streams 622 in FIG. 6) of bins indicated as failing to meet coverage threshold.

In aspects, the render-passes 750 (e.g., a set of renders or a set of render-passes) may include a render-pass for each bin of the set of bins 707 having a pixel coverage that meets the coverage threshold, however, the render-passes for bins (e.g., the bin 2 714 and the bin 4 718) with pixel coverage that fails to meet the coverage threshold may differ and be combined into a single render, according to aspects herein for pixel coverage based binning, from render-passes for bins with pixel coverage that meets the coverage threshold.

In the context of the bin 1 712, which has pixel coverage that meets the coverage threshold, an associated render-pass of the render-passes 750 for the render target 706 may include a load (e.g., at 708 (A)) of the bin 1 712 into the graphics memory 703. The graphics processor 702 may execute (e.g., at 709 (B)) all draws visible in the bin 1 712 and skip dead draws based on a visibility stream, e.g., via a pixel shader, and may render (e.g., at 710 (C)) the pixel shader output of the visible draws of the bin 1 712 to the render target 706 in the graphics memory 703. After rendering (e.g., at 710 (C)), the bin 1 712 of the render target 706 may be stored (e.g., at 711 (D)) from the graphics memory 703 to the system memory 704. The operations (A), (B), (C), and (D) may be repeated for each other bin in the set of bins 707 having pixel coverage that meets the coverage threshold (e.g., for the bin 3 716, the bin 5 720, the bin 6 722, the bin 7 724, the bin 8 726, and the bin 9 728).

In the context of the bin 2 714, which has pixel coverage that fails to meet the coverage threshold, an associated render-pass of the render-passes 750 for the render target 706 may skip or refrain from performing a load (e.g., at 708 (A)) of the bin 2 714 into the graphics memory 703. In aspects, the graphics processor 702 may also skip or refrain from performing an in-order execute (e.g., at 740 (B−2)) with respect to the numerical ordering of the render-passes 750 based on bin numbers. In the described aspects for FIG. 7, a single execute (at 740 (B−2)) for all draws visible in the bin 2 714 and the bin 4 718, as well as associated skipped dead draws based on a visibility stream, e.g., via a pixel shader, may be performed together as part of a last render-pass of the render-passes 750, e.g., subsequent to the render-pass for the bin 9 528. The graphics processor 702 may then render (e.g., at 742 (C−2)) the pixel shader output of the visible draws of the bin 2 714 and the bin 4 718 together for the render target 706 in the system memory 704, instead of the graphics memory 703, using a bin scissor array (e.g., a bin scissor operation for each of the bins indicated, for failing to meet the coverage threshold, as an array of bin scissor operations).

After rendering (e.g., at 742 (C−2)), the store (e.g., at 711 (D)) from the graphics memory 703 to the system memory 704 may be skipped or refrained from for the bin 2 714 and the bin 4 718 (e.g., based on the direct render to the system memory 704). The operations (B−2) and (C−2) may thus be performed a single time for each bin in the set of bins 707 having pixel coverage that fails to meet the coverage threshold. Accordingly, renders of the render-passes 750 may be performed in sequential order based on bin number for bins with pixel coverage meeting the coverage threshold (e.g., as first to last: the bin 1 712, the bin 3 716, the bin 5 720, the bin 6 722, the bin 7 724, the bin 8 726, and the bin 9 728, followed by the bin 2 714 together with the bin 4 718 in a single render-pass, as shown).

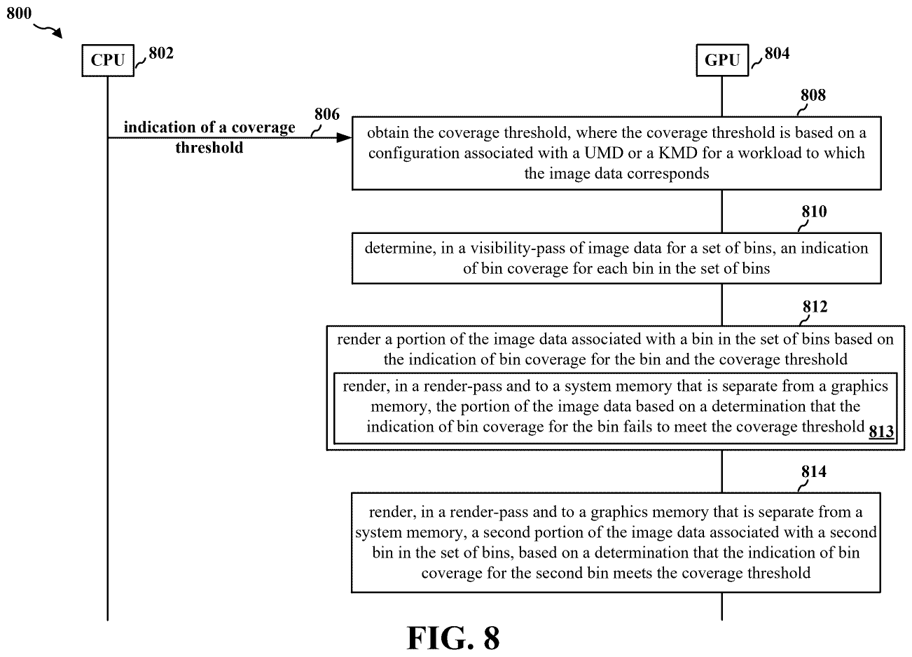

FIG. 8 is a call flow diagram 800 illustrating example communications between a CPU 802 and a graphics processor 804 in accordance with one or more techniques of this disclosure. In aspects, call flow diagram 800 is described for pixel coverage based binning. In an example, the graphics processor 804 may be or include a GPU and/or the processing unit 120. In aspects, the CPU 802 and/or the graphics processor 804 may be or may comprise a wireless communication device. While a bin, or a bin and a second bin, are described in aspects as examples for purposes of brevity and illustrative clarity, aspects are extensible to any number of bins, such as a set of bins (e.g., one or more bins).

The graphics processor 804 may be configured to determine/obtain (at 808) a coverage threshold. In aspects, the coverage threshold may be based on a configuration associated with a UMD or a KMD for a workload to which the image data corresponds. To obtain (at 808) the coverage threshold, the graphics processor 804 may be configured to receive, and the CPU 802 may be configured to provide, an indication 806 of the coverage threshold, which may indicate the coverage threshold. In some aspects, the graphics processor 804 may be configured to retrieve the coverage threshold and/or the indication 806 of the coverage threshold.

At 810, the graphics processor 804 may be configured determine (at 810), in a visibility-pass of image data for a set of bins, an indication of bin coverage for each bin in the set of bins. In aspects, to determine (at 810) the indications of bin coverage, the graphics processor 804 may be configured to calculate the bin coverage for each bin in the set of bins and/or to adjust in a data structure, for each bin in the set of bins and based on the bin coverage for each bin, a respective indication of bin coverage that is associated with the coverage threshold. The graphics processor 804 may be configured to calculate the bin coverage via/using a rasterizer. In aspects, the adjustment(s) may be made using a command processor.

At 812, the graphics processor 804 may be configured to render, e.g., to a system memory, a portion of the image data associated with a bin in the set of bins based on the indication of bin coverage for the bin and a coverage threshold. At 813, which may comprise the render (at 812), the graphics processor 804 may be configured to render, in a render-pass and to a system memory that is separate from a graphics memory, the portion of the image data based on a determination that the indication of bin coverage for the bin fails to meet the coverage threshold. In aspects, the system memory may be a video memory that is separate from a graphics memory dedicated to a GPU. The graphics processor 804 may be configured to execute, prior to the render (at 812), a set of draw operations, e.g., a draw operation(s), associated with the bin to generate draw data for the render. In such aspects, the render (at 812) may be associated with the generated draw data. In some aspects, to render (at 812), the graphics processor 804 may be configured, for each render in a set of renders/renderings: to determine to refrain from performing, e.g., prior to the render (at 812), a load operation to the graphics memory for the portion of the image data in the bin, and to determine to refrain from performing, e.g., subsequent to the render (at 812), a store operation to the system memory for the portion of the image data in the bin.

In aspects, pixel coverage based binning may include a visibility-pass and render-passes for pixel coverage based binning with a single render-pass over each of the low coverage bins. The graphics processor 804, to render (at 812) the portion of the image data, may be configured to perform a single render-pass operation. As one example, the graphics processor 804, to render (at 812) the portion of the image data, may be configured to render (at 812), as a final rendering in a final render-pass, the portion of the image data. In aspects, such a single/final render-pass operation may include: a render of the portion of the image data as a combined render of the image data associated with respective bins of the subset of bins. As one example, the graphics processor 804, to render (at 812) the portion of the image data, may be configured to render (at 812), as a part of the final render in the final render-pass and combined with the portion of the image data, a second portion of the image data associated with a second bin in the set of bins based on the indication of bin coverage for the second bin and the coverage threshold. In aspects, render of the portion of the image data as the combined render of the image data may include: an execution, prior to the combined/final render, of a total number of draw operations associated with the bin and the second bin to generate combined draw data, and the combined/final render may be associated with the generated combined draw data. In aspects, the combined draw data may comprise a combined visibility stream over the bin and the second bin (e.g., a plurality of bins). In some aspects, the render of the portion of the image data as the combined render of the image data may be based on a combined bin scissor operation, e.g., a bin scissor array. For example, the graphics processor 804, to render (at 812) the portion of the image data, may be configured to render based on a combined bin scissor operation. In some aspects, the render of the portion of the image data as the combined render of the image data may include to determine to refrain from performing, for each bin in the subset of bins (e.g., for each of the bin and the second bin), a set of render operations (e.g., operations associated with renderings performed in render-passes). The set of render operations may include an individual bin load to a graphics memory, that is separate from a system memory, for the image data (e.g., in a respective bin of the subset of bins such as the bin and the second bin), a set of individual draws, an individual rendering, and/or an individual store to the system memory for the image data (e.g., in the respective bin of the subset of bins such as for the bin and the second bin). To determine to refrain from performing, for each bin in the subset of bins such as the bin and the second bin, the set of render operations, the graphics processor 804 may be configured to determine to refrain from performing the set of render operations prior to the final render (e.g., of the portion of the image data as the combined render of the image data). To determine to refrain from performing (e.g., the set of render operations for each bin in the subset of bins, such as the bin and the second bin) the graphics processor 804 may be configured to determine to refrain from performing the set of render operations subsequent to a set of renders, to the graphics memory, of a remaining portion of the image data associated with a remaining subset of the set of bins, which excludes the subset of bins. For example, the graphics processor 804 may be configured to determine to refrain from performing subsequent to at least one render, to the graphics memory, of the image data respectively associated with at least one bin of the set of bins, which may exclude the bin and the second bin. In aspects, the set of renders/the at least one render may be associated with respective indications of bin coverage for remaining bins of the remaining subset that meet the coverage threshold, or may be associated with respective indications of bin coverage for the at least one bin that meets the coverage threshold.

At 814, the graphics processor 804 may be configured to render, in a render-pass and to a graphics memory that is separate from a system memory, a second portion of the image data associated with a second bin in the set of bins, based on a determination that the indication of bin coverage for the second bin meets the coverage threshold. In aspects, to this end, the graphics processor may be configured render, to a graphics memory that is separate from a system memory, a remaining/second portion of the image data associated with a remaining subset of the set of bins/a second bin or another bin, e.g., which may exclude the subset of bins/the bin, based on a determination that the indication of bin coverage for the second bin meets the coverage threshold (e.g., respective indications of bin coverage for remaining bins of the remaining subset that meet the coverage threshold). In aspects, the render (at 814) may include to perform a set of remaining render operations. The performance of the set of remaining render operations may include, for each remaining render operation in the set of remaining render operations/for the second portion of the image data: a load, to the graphics memory, of respective image data in a respective bin of the remaining subset/the second portion of the image data, an execution, prior to the render, of a set of draw operations/a draw operation(s) associated with the respective bin of the subset of bins/the second bin or the other bin to generate draw data, a render of the remaining/second portion of the image data, in association with or based on the generated draw data, e.g., as the set of remaining render operations associated with respective bins of the remaining subset, a store, to the system memory, of the respective/rendered image data in the respective/second bin (e.g., of the remaining subset), and/or the like. In some aspects, the render (at 814) may include a render of the remaining/second portion of the image data prior to the render, to the system memory, of the portion of the image data.

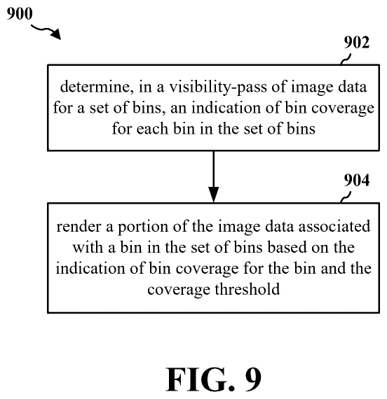

FIG. 9 is a flowchart 900 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-8. In aspects, the apparatus may be or may comprise a wireless communication device.

At 902, the apparatus may determine, in a visibility-pass of image data for a set of bins, an indication of bin coverage for each bin in the set of bins. For example, referring to FIG. 8, at 810, the graphics processor 804 may be configured determine (at 810) (e.g., at 608, 610 in FIG. 6), in a visibility-pass (e.g., 600 in FIG. 6; 760 in FIG. 7) of image data (e.g., 570 in FIG. 5; 670 in FIG. 6; 770 in FIG. 7) for a set of bins (e.g., 507 in FIG. 5; 707 in FIG. 7), an indication of bin coverage (e.g., 580 in FIG. 5; 624, 626, 680 in FIG. 6; 766, 780 in FIG. 7) for each bin in the set of bins (e.g., 507 in FIG. 5; 707 in FIG. 7). In aspects, to determine (at 810) (e.g., at 608, 610 in FIG. 6) the indications of bin coverage (e.g., 580 in FIG. 5; 624, 626, 680 in FIG. 6; 766, 780 in FIG. 7), the graphics processor 804 may be configured to calculate (e.g., at 608 in FIG. 6) the bin coverage (e.g., 580 in FIG. 5; 624, 626, 680 in FIG. 6; 766, 780 in FIG. 7) for each bin in the set of bins (e.g., 507 in FIG. 5; 707 in FIG. 7) and/or to adjust in a data structure (e.g., at 580 in FIG. 5; 680 in FIG. 6; 780 in FIG. 7), for each bin in the set of bins (e.g., 507 in FIG. 5; 707 in FIG. 7) and based on the bin coverage (e.g., 580 in FIG. 5; 624, 626, 680 in FIG. 6; 766, 780 in FIG. 7) for each bin, a respective indication of bin coverage (e.g., 580 in FIG. 5; 624, 626, 680 in FIG. 6; 766, 780 in FIG. 7) that is associated with the coverage threshold (e.g., 699 in FIG. 6). The graphics processor 804 may be configured to calculate (e.g., at 608 in FIG. 6) the bin coverage (e.g., 580 in FIG. 5; 624, 626, 680 in FIG. 6; 766, 780 in FIG. 7) via/using a rasterizer. In aspects, the adjustment(s) may be made using a command processor.

At 904, the apparatus may render a portion of the image data associated with a bin in the set of bins based on the indication of bin coverage for the bin and the coverage threshold. For example, referring to FIG. 8, at 812, the graphics processor 804 may be configured to render (e.g., at 542 in FIG. 5; at 742 in FIG. 7), e.g., to a system memory (e.g., 504 in in FIG. 5; 704 in FIG. 7), a portion of the image data (e.g., 570 in FIG. 5; 670 in FIG. 6; 770 in FIG. 7) associated with a bin in the set of bins (e.g., 507 in FIG. 5; 707 in FIG. 7) based on the indication of bin coverage (e.g., 580 in FIG. 5; 624, 626, 680 in FIG. 6; 766, 780 in FIG. 7) for the bin (e.g., 514, 518 in FIG. 5; 714, 718 in FIG. 7) and a coverage threshold (e.g., 699 in FIG. 6). At 813, which may comprise the render (at 812) (e.g., at 542 in FIG. 5; at 742 in FIG. 7), the graphics processor 804 may be configured to render, in a render-pass (e.g., of 550 in FIG. 5; of 750 in FIG. 7) and to a system memory (e.g., 504 in FIG. 5; 704 in FIG. 7) that is separate from a graphics memory (e.g., 503 in FIG. 5; 703 in FIG. 7), the portion of the image data (e.g., 570 in FIG. 5; 670 in FIG. 6; 770 in FIG. 7) based on a determination that the indication of bin coverage (e.g., 580 in FIG. 5; 624, 626, 680 in FIG. 6; 766, 780 in FIG. 7) for the bin (e.g., 514, 518 in FIG. 5; 714, 718 in FIG. 7) fails to meet the coverage threshold (e.g., 699 in FIG. 6). In aspects, the system memory (e.g., 504 in in FIG. 5; 704 in FIG. 7) may be a video memory that is separate from a graphics memory (e.g., 503 in FIG. 5; 703 in FIG. 7) dedicated to a GPU. The graphics processor 804 may be configured to execute (e.g., at 540 in FIG. 5; at 740 in FIG. 7), prior to the render (at 812) (e.g., at 542 in FIG. 5; at 742 in FIG. 7), a set of draw operations, e.g., a draw operation(s), associated with the bin (e.g., 514, 518 in FIG. 5; 714, 718 in FIG. 7) to generate draw data for the render (e.g., at 542 in FIG. 5; at 742 in FIG. 7). In such aspects, the render (at 812) (e.g., at 542 in FIG. 5; at 742 in FIG. 7) may be associated with the generated draw data. In some aspects, to render (at 812) (e.g., at 542 in FIG. 5; at 742 in FIG. 7), the graphics processor 804 may be configured, for each render in a set of renders/renderings (e.g., 550 in FIG. 5; 750 in FIG. 7): to determine to refrain from performing, e.g., prior to the render (at 812) (e.g., at 542 in FIG. 5; at 742 in FIG. 7), a load (e.g., 508 in FIG. 5; 708 in FIG. 7) operation to the graphics memory (e.g., 503 in FIG. 5; 703 in FIG. 7) for the portion of the image data (e.g., 570 in FIG. 5; 670 in FIG. 6; 770 in FIG. 7) in the bin (e.g., 514, 518 in FIG. 5; 714, 718 in FIG. 7), and to determine to refrain from performing, e.g., subsequent to the render (at 812) (e.g., at 542 in FIG. 5; at 742 in FIG. 7), a store (e.g., 511 in FIG. 5; 711 in FIG. 7) operation to the system memory (e.g., 504 in in FIG. 5; 704 in FIG. 7) for the portion of the image data (e.g., 570 in FIG. 5; 670 in FIG. 6; 770 in FIG. 7) in the bin (e.g., 514, 518 in FIG. 5; 714, 718 in FIG. 7).

In aspects, pixel coverage based binning may include a visibility-pass (e.g., 600 in FIG. 6) and render-passes (e.g., 550 in FIG. 5; 750 in FIG. 7) for pixel coverage based binning with a single render-pass (e.g., Bin 2 and Bin 4 of 750 in FIG. 7) over each/all of the low coverage bins (e.g., 514, 518 in FIG. 5; 714, 718 in FIG. 7). The graphics processor 804, to render (at 812) (e.g., at 542 in FIG. 5; at 742 in FIG. 7) the portion of the image data (e.g., 570 in FIG. 5; 670 in FIG. 6; 770 in FIG. 7), may be configured to perform a single render-pass operation (e.g., Bin 2 and Bin 4 of 750 in FIG. 7). As one example, the graphics processor 804, to render (at 812) (e.g., at 542 in FIG. 5; at 742 in FIG. 7) the portion of the image data (e.g., 570 in FIG. 5; 670 in FIG. 6; 770 in FIG. 7), may be configured to render (at 812) (e.g., at 542 in FIG. 5; at 742 in FIG. 7), as a final rendering in a final render-pass (e.g., Bin 2 and Bin 4 of 750 in FIG. 7), the portion of the image data (e.g., 570 in FIG. 5; 670 in FIG. 6; 770 in FIG. 7). In aspects, such a single/final render-pass (e.g., ‘Bin 2 and Bin 4’ of 750 in FIG. 7) operation may include: a render (e.g., 742 in FIG. 7) of the portion of the image data (e.g., 570 in FIG. 5; 670 in FIG. 6; 770 in FIG. 7) as a combined render of the image data (e.g., 570 in FIG. 5; 670 in FIG. 6; 770 in FIG. 7) associated with respective bins of the subset of bins (e.g., Bin 2 714, Bin 4 718 in FIG. 7). As one example, the graphics processor 804, to render (at 812) (e.g., at 542 in FIG. 5; at 742 in FIG. 7) the portion of the image data (e.g., 570 in FIG. 5; 670 in FIG. 6; 770 in FIG. 7), may be configured to render (at 812) (e.g., at 542 in FIG. 5; at 742 in FIG. 7), as a part of the final render in the final render-pass (e.g., Bin 2 and Bin 4 of 750 in FIG. 7) and combined with the portion of the image data (e.g., for Bin 2 714 in FIG. 7), a second portion of the image data (e.g., 570 in FIG. 5; 670 in FIG. 6; 770 in FIG. 7) associated with a second bin (e.g., for Bin 4 718 in FIG. 7) in the set of bins (e.g., 507 in FIG. 5; 707 in FIG. 7) based on the indication of bin coverage (e.g., 580 in FIG. 5; 624, 626, 680 in FIG. 6; 766, 780 in FIG. 7) for the second bin (e.g., for Bin 2 714 in FIG. 7) and the coverage threshold (e.g., 699 in FIG. 6). In aspects, the rendering (e.g., at 542 in FIG. 5; at 742 in FIG. 7) of the portion of the image data (e.g., 570 in FIG. 5; 670 in FIG. 6; 770 in FIG. 7) as the combined render of the image data (e.g., 570 in FIG. 5; 670 in FIG. 6; 770 in FIG. 7) may include: an execution (e.g., at 740 in FIG. 7), prior to the combined/final render (e.g., Bin 2 and Bin 4 of 750 in FIG. 7), of a total number of draw operations associated with the bin (e.g., 514/518 in FIG. 5; 714/718 in FIG. 7) and the second bin (e.g., 514/518 in FIG. 5; 714/718 in FIG. 7) to generate combined draw data, and the combined/final render (e.g., Bin 2 and Bin 4 of 750 in FIG. 7) may be associated with the generated combined draw data. In aspects, the combined draw data may comprise a combined visibility stream (e.g., at 764 in FIG. 7) over the bin and the second bin (e.g., 514, 518 in FIG. 5; 714, 718 in FIG. 7) (e.g., a plurality of bins). In some aspects, the render (e.g., at 542 in FIG. 5; at 742 in FIG. 7) of the portion of the image data (e.g., 570 in FIG. 5; 670 in FIG. 6; 770 in FIG. 7) as the combined render of the image data (e.g., 570 in FIG. 5; 670 in FIG. 6; 770 in FIG. 7) may be based on a combined bin scissor operation, e.g., a bin scissor array. For example, the graphics processor 804, to render (at 812) (e.g., at 742 in FIG. 7) the portion of the image data (e.g., 570 in FIG. 5; 670 in FIG. 6; 770 in FIG. 7), may be configured to render based on a combined bin scissor operation. In some aspects, the render (e.g., at 542 in FIG. 5; at 742 in FIG. 7) of the portion of the image data (e.g., 570 in FIG. 5; 670 in FIG. 6; 770 in FIG. 7) as the combined render of the image data (e.g., 570 in FIG. 5; 670 in FIG. 6; 770 in FIG. 7) may include to determine to refrain from performing, for each bin in the subset of bins (e.g., 514, 518 in FIG. 5; 714, 718 in FIG. 7) (e.g., for each of the bin (e.g., 514/518 in FIG. 5; 714/718 in FIG. 7) and the second bin (e.g., 518 in FIG. 5; 718 in FIG. 7)), a set of render operations (e.g., 508, 509, 510, 511 in FIG. 5; 708, 709, 710, 711 in FIG. 7) (e.g., operations associated with renderings performed in render-passes (e.g., 550 in FIG. 5; 750 in FIG. 7)). The set of render operations may include an individual bin load (e.g., 508 in FIG. 5; 708 in FIG. 7) to a graphics memory (e.g., 503 in FIG. 5; 703 in FIG. 7), that is separate from a system memory (e.g., 504 in in FIG. 5; 704 in FIG. 7), for the image data (e.g., 570 in FIG. 5; 670 in FIG. 6; 770 in FIG. 7) (e.g., in a respective bin of the subset of bins (e.g., 514, 518 in FIG. 5; 714, 718 in FIG. 7) such as the bin and the second bin (e.g., 514, 518 in FIG. 5; 714, 718 in FIG. 7)), a set of individual draws (e.g., at 509 in FIG. 5; at 709 in FIG. 7), an individual rendering (e.g., at 510 in FIG. 5; at 710 in FIG. 7), and/or an individual store (e.g., 511 in FIG. 5; 711 in FIG. 7) to the system memory (e.g., 504 in in FIG. 5; 704 in FIG. 7) for the image data (e.g., 570 in FIG. 5; 670 in FIG. 6; 770 in FIG. 7) (e.g., in the respective bin of the subset of bins such as for the bin and the second bin (e.g., 514, 518 in FIG. 5; 714, 718 in FIG. 7)). To determine to refrain from performing, for each bin in the subset of bins such as the bin and the second bin (e.g., 514, 518 in FIG. 5; 714, 718 in FIG. 7), the set of render operations (e.g., 508, 509, 510, 511 in FIG. 5; 708, 709, 710, 711 in FIG. 7), the graphics processor 804 may be configured to determine to refrain from performing the set of render operations (e.g., 508, 509, 510, 511 in FIG. 5; 708, 709, 710, 711 in FIG. 7) prior to the final render (e.g., of the portion of the image data (e.g., 570 in FIG. 5; 670 in FIG. 6; 770 in FIG. 7) as the combined render of the image data (e.g., 570 in FIG. 5; 670 in FIG. 6; 770 in FIG. 7)). To determine to refrain from performing (e.g., the set of render operations 508, 509, 510, 511 in FIG. 5; 708, 709, 710, 711 for each bin in the subset of bins, such as the bin and the second bin (e.g., 514, 518 in FIG. 5; 714, 718 in FIG. 7)) the graphics processor 804 may be configured to determine to refrain from performing the set of render operations (e.g., 508, 509, 510, 511 in FIG. 5; 708, 709, 710, 711 in FIG. 7) subsequent to a set of renders (e.g., at 710 for Bins 1, 3, 5, 6, 7, 8, 9 in FIG. 7), to the graphics memory (e.g., 503 in FIG. 5; 703 in FIG. 7), of a remaining portion of the image data (e.g., 570 in FIG. 5; 670 in FIG. 6; 770 in FIG. 7) associated with a remaining subset (e.g., 512, 516, 520, 522, 524, 526, 528 in FIG. 5; 712, 716, 720, 722, 724, 726, 728 in FIG. 7) of the set of bins (e.g., 507 in FIG. 5; 707 in FIG. 7), which excludes the subset of bins (e.g., 514, 518 in FIG. 5; 714, 718 in FIG. 7). For example, the graphics processor 804 may be configured to determine to refrain from performing (e.g., the set of render operations (e.g., 508, 509, 510, 511 in FIG. 5; 708, 709, 710, 711 in FIG. 7)) subsequent to at least one render (e.g., at 710 for Bins 1, 3, 5, 6, 7, 8, 9 in FIG. 7), to the graphics memory (e.g., 503 in FIG. 5; 703 in FIG. 7), of the image data (e.g., 570 in FIG. 5; 670 in FIG. 6; 770 in FIG. 7) respectively associated with at least one bin (e.g., 512, 516, 520, 522, 524, 526, 528 in FIG. 5; 712, 716, 720, 722, 724, 726, 728 in FIG. 7) of the set of bins (e.g., 507 in FIG. 5; 707 in FIG. 7), which may exclude the bin and the second bin (e.g., 514, 518 in FIG. 5; 714, 718 in FIG. 7). In aspects, the set of renders/the at least one render (e.g., at 710 for Bins 1, 3, 5, 6, 7, 8, 9 in FIG. 7) may be associated with respective indications of bin coverage (e.g., 580 in FIG. 5; 624, 626, 680 in FIG. 6; 766, 780 in FIG. 7) for remaining bins of the remaining subset (e.g., 512, 516, 520, 522, 524, 526, 528 in FIG. 5; 712, 716, 720, 722, 724, 726, 728 in FIG. 7) that meet the coverage threshold (e.g., 699 in FIG. 6), or may be associated with respective indications of bin coverage (e.g., 580 in FIG. 5; 624, 626, 680 in FIG. 6; 766, 780 in FIG. 7) for the at least one bin (e.g., 512, 516, 520, 522, 524, 526, 528 in FIG. 5; 712, 716, 720, 722, 724, 726, 728 in FIG. 7) that meets the coverage threshold (e.g., 699 in FIG. 6).

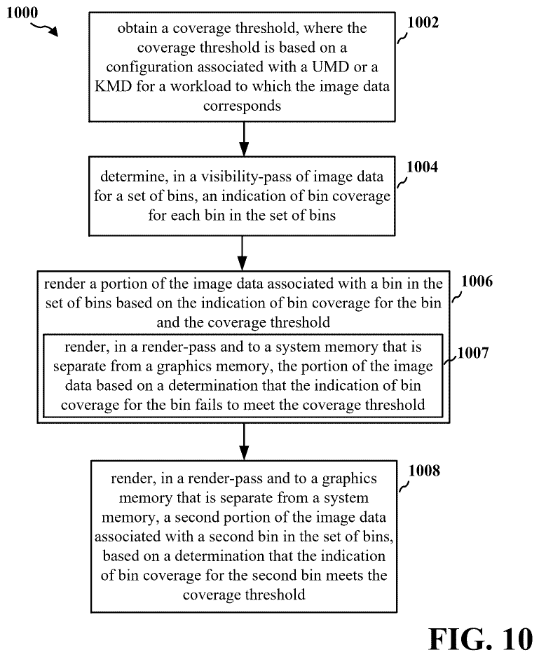

FIG. 10 is a flowchart 1000 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-8. In aspects, the apparatus may be or may comprise a wireless communication device.

At 1002, the apparatus may obtain the coverage threshold, where the coverage threshold is based on a configuration associated with a UMD or a KMD for a workload to which the image data corresponds. For example, referring to FIG. 8, the graphics processor 804 may be configured determine/obtain (at 808) a coverage threshold (e.g., 699 in FIG. 6). In aspects, the coverage threshold (e.g., 699 in FIG. 6) may be based on a configuration associated with a UMD or a KMD (e.g., 612 in FIG. 6) for a workload to which the image data (e.g., 570 in FIG. 5; 670 in FIG. 6; 770 in FIG. 7) corresponds. To obtain (at 808) the coverage threshold (e.g., 699 in FIG. 6), the graphics processor 804 may be configured to receive, and the CPU 802 may be configured to provide, an indication 806 of the coverage threshold (e.g., 699 in FIG. 6), which may indicate the coverage threshold (e.g., 699 in FIG. 6). In some aspects, the graphics processor 804 may be configured to retrieve the coverage threshold (e.g., 699 in FIG. 6) and/or the indication 806 of the coverage threshold (e.g., 699 in FIG. 6).

At 1004, the apparatus may determine, in association with a visibility-pass of image data for a set of bins, an indication of bin coverage for each bin in the set of bins. For example, referring to FIG. 8, at 810, the graphics processor 804 may be configured determine (at 810) (e.g., at 608, 610 in FIG. 6), in a visibility-pass (e.g., 600 in FIG. 6; 760 in FIG. 7) of image data (e.g., 570 in FIG. 5; 670 in FIG. 6; 770 in FIG. 7) for a set of bins (e.g., 507 in FIG. 5; 707 in FIG. 7), an indication of bin coverage (e.g., 580 in FIG. 5; 624, 626, 680 in FIG. 6; 766, 780 in FIG. 7) for each bin in the set of bins (e.g., 507 in FIG. 5; 707 in FIG. 7). In aspects, to determine (at 810) (e.g., at 608, 610 in FIG. 6) the indications of bin coverage (e.g., 580 in FIG. 5; 624, 626, 680 in FIG. 6; 766, 780 in FIG. 7), the graphics processor 804 may be configured to calculate (e.g., at 608 in FIG. 6) the bin coverage (e.g., 580 in FIG. 5; 624, 626, 680 in FIG. 6; 766, 780 in FIG. 7) for each bin in the set of bins (e.g., 507 in FIG. 5; 707 in FIG. 7) and/or to adjust in a data structure (e.g., at 580 in FIG. 5; 680 in FIG. 6; 780 in FIG. 7), for each bin in the set of bins (e.g., 507 in FIG. 5; 707 in FIG. 7) and based on the bin coverage (e.g., 580 in FIG. 5; 624, 626, 680 in FIG. 6; 766, 780 in FIG. 7) for each bin, a respective indication of bin coverage (e.g., 580 in FIG. 5; 624, 626, 680 in FIG. 6; 766, 780 in FIG. 7) that is associated with the coverage threshold (e.g., 699 in FIG. 6). The graphics processor 804 may be configured to calculate (e.g., at 608 in FIG. 6) the bin coverage (e.g., 580 in FIG. 5; 624, 626, 680 in FIG. 6; 766, 780 in FIG. 7) via/using a rasterizer. In aspects, the adjustment(s) may be made using a command processor.

At 1006, the apparatus may render, to a system memory, a portion of the image data associated with a subset of bins in the set of bins based on respective indications of bin coverage for each of the subset of bins that fail to meet a coverage threshold. For example, referring to FIG. 8, at 812, the graphics processor 804 may be configured to render (e.g., at 542 in FIG. 5; at 742 in FIG. 7), e.g., to a system memory (e.g., 504 in in FIG. 5; 704 in FIG. 7), a portion of the image data (e.g., 570 in FIG. 5; 670 in FIG. 6; 770 in FIG. 7) associated with a bin in the set of bins (e.g., 507 in FIG. 5; 707 in FIG. 7) based on the indication of bin coverage (e.g., 580 in FIG. 5; 624, 626, 680 in FIG. 6; 766, 780 in FIG. 7) for the bin (e.g., 514, 518 in FIG. 5; 714, 718 in FIG. 7) and a coverage threshold (e.g., 699 in FIG. 6). At 813, which may comprise the render (at 812) (e.g., at 542 in FIG. 5; at 742 in FIG. 7), the graphics processor 804 may be configured to render, in a render-pass (e.g., of 550 in FIG. 5; of 750 in FIG. 7) and to a system memory (e.g., 504 in FIG. 5; 704 in FIG. 7) that is separate from a graphics memory (e.g., 503 in FIG. 5; 703 in FIG. 7), the portion of the image data (e.g., 570 in FIG. 5; 670 in FIG. 6; 770 in FIG. 7) based on a determination that the indication of bin coverage (e.g., 580 in FIG. 5; 624, 626, 680 in FIG. 6; 766, 780 in FIG. 7) for the bin (e.g., 514, 518 in FIG. 5; 714, 718 in FIG. 7) fails to meet the coverage threshold (e.g., 699 in FIG. 6). In aspects, the system memory (e.g., 504 in in FIG. 5; 704 in FIG. 7) may be a video memory that is separate from a graphics memory (e.g., 503 in FIGS. 5, 703 in FIG. 7) dedicated to a GPU. The graphics processor 804 may be configured to execute (e.g., at 540 in FIG. 5; at 740 in FIG. 7), prior to the render (at 812) (e.g., at 542 in FIG. 5; at 742 in FIG. 7), a set of draw operations, e.g., a draw operation(s), associated with the bin (e.g., 514, 518 in FIG. 5; 714, 718 in FIG. 7) to generate draw data for the render (e.g., at 542 in FIG. 5; at 742 in FIG. 7). In such aspects, the render (at 812) (e.g., at 542 in FIG. 5; at 742 in FIG. 7) may be associated with the generated draw data. In some aspects, to render (at 812) (e.g., at 542 in FIG. 5; at 742 in FIG. 7), the graphics processor 804 may be configured, for each render in a set of renders/renderings (e.g., 550 in FIG. 5; 750 in FIG. 7): to determine to refrain from performing, e.g., prior to the render (at 812) (e.g., at 542 in FIG. 5; at 742 in FIG. 7), a load (e.g., 508 in FIG. 5; 708 in FIG. 7) operation to the graphics memory (e.g., 503 in FIG. 5; 703 in FIG. 7) for the portion of the image data (e.g., 570 in FIG. 5; 670 in FIG. 6; 770 in FIG. 7) in the bin (e.g., 514, 518 in FIG. 5; 714, 718 in FIG. 7), and to determine to refrain from performing, e.g., subsequent to the render (at 812) (e.g., at 542 in FIG. 5; at 742 in FIG. 7), a store (e.g., 511 in FIG. 5; 711 in FIG. 7) operation to the system memory (e.g., 504 in in FIG. 5; 704 in FIG. 7) for the portion of the image data (e.g., 570 in FIG. 5; 670 in FIG. 6; 770 in FIG. 7) in the bin (e.g., 514, 518 in FIG. 5; 714, 718 in FIG. 7).

In aspects, pixel coverage based binning may include a visibility-pass (e.g., 600 in FIG. 6) and render-passes (e.g., 550 in FIG. 5; 750 in FIG. 7) for pixel coverage based binning with a single render-pass (e.g., Bin 2 and Bin 4 of 750 in FIG. 7) over each/all of the low coverage bins (e.g., 514, 518 in FIG. 5; 714, 718 in FIG. 7). The graphics processor 804, to render (at 812) (e.g., at 542 in FIG. 5; at 742 in FIG. 7) the portion of the image data (e.g., 570 in FIG. 5; 670 in FIG. 6; 770 in FIG. 7), may be configured to perform a single render-pass operation (e.g., Bin 2 and Bin 4 of 750 in FIG. 7). As one example, the graphics processor 804, to render (at 812) (e.g., at 542 in FIG. 5; at 742 in FIG. 7) the portion of the image data (e.g., 570 in FIG. 5; 670 in FIG. 6; 770 in FIG. 7), may be configured to render (at 812) (e.g., at 542 in FIG. 5; at 742 in FIG. 7), as a final rendering in a final render-pass (e.g., Bin 2 and Bin 4 of 750 in FIG. 7), the portion of the image data (e.g., 570 in FIG. 5; 670 in FIG. 6; 770 in FIG. 7). In aspects, such a single/final render-pass (e.g., ‘Bin 2 and Bin 4’ of 750 in FIG. 7) operation may include: a render (e.g., 742 in FIG. 7) of the portion of the image data (e.g., 570 in FIG. 5; 670 in FIG. 6; 770 in FIG. 7) as a combined render of the image data (e.g., 570 in FIG. 5; 670 in FIG. 6; 770 in FIG. 7) associated with respective bins of the subset of bins (e.g., Bin 2 714, Bin 4 718 in FIG. 7). As one example, the graphics processor 804, to render (at 812) (e.g., at 542 in FIG. 5; at 742 in FIG. 7) the portion of the image data (e.g., 570 in FIG. 5; 670 in FIG. 6; 770 in FIG. 7), may be configured to render (at 812) (e.g., at 542 in FIG. 5; at 742 in FIG. 7), as a part of the final render in the final render-pass (e.g., Bin 2 and Bin 4 of 750 in FIG. 7) and combined with the portion of the image data (e.g., for Bin 2 714 in FIG. 7), a second portion of the image data (e.g., 570 in FIG. 5; 670 in FIG. 6; 770 in FIG. 7) associated with a second bin (e.g., for Bin 4 718 in FIG. 7) in the set of bins (e.g., 507 in FIG. 5; 707 in FIG. 7) based on the indication of bin coverage (e.g., 580 in FIG. 5; 624, 626, 680 in FIG. 6; 766, 780 in FIG. 7) for the second bin (e.g., for Bin 2 714 in FIG. 7) and the coverage threshold (e.g., 699 in FIG. 6). In aspects, the rendering (e.g., at 542 in FIG. 5; at 742 in FIG. 7) of the portion of the image data (e.g., 570 in FIG. 5; 670 in FIG. 6; 770 in FIG. 7) as the combined render of the image data (e.g., 570 in FIG. 5; 670 in FIG. 6; 770 in FIG. 7) may include: an execution (e.g., at 740 in FIG. 7), prior to the combined/final render (e.g., Bin 2 and Bin 4 of 750 in FIG. 7), of a total number of draw operations associated with the bin (e.g., 514/518 in FIG. 5; 714/718 in FIG. 7) and the second bin (e.g., 514/518 in FIG. 5; 714/718 in FIG. 7) to generate combined draw data, and the combined/final render (e.g., Bin 2 and Bin 4 of 750 in FIG. 7) may be associated with the generated combined draw data. In aspects, the combined draw data may comprise a combined visibility stream (e.g., at 764 in FIG. 7) over the bin and the second bin (e.g., 514, 518 in FIG. 5; 714, 718 in FIG. 7) (e.g., a plurality of bins). In some aspects, the render (e.g., at 542 in FIG. 5; at 742 in FIG. 7) of the portion of the image data (e.g., 570 in FIG. 5; 670 in FIG. 6; 770 in FIG. 7) as the combined render of the image data (e.g., 570 in FIG. 5. 670 in FIG. 6; 770 in FIG. 7) may be based on a combined bin scissor operation, e.g., a bin scissor array. For example, the graphics processor 804, to render (at 812) (e.g., at 742 in FIG. 7) the portion of the image data (e.g., 570 in FIG. 5; 670 in FIG. 6; 770 in FIG. 7), may be configured to render based on a combined bin scissor operation. In some aspects, the render (e.g., at 542 in FIG. 5; at 742 in FIG. 7) of the portion of the image data (e.g., 570 in FIG. 5; 670 in FIG. 6; 770 in FIG. 7) as the combined render of the image data (e.g., 570 in FIG. 5; 670 in FIG. 6; 770 in FIG. 7) may include to determine to refrain from performing, for each bin in the subset of bins (e.g., 514, 518 in FIG. 5; 714, 718 in FIG. 7) (e.g., for each of the bin (e.g., 514/518 in FIG. 5; 714/718 in FIG. 7) and the second bin (e.g., 518 in FIG. 5; 718 in FIG. 7)), a set of render operations (e.g., 508, 509, 510, 511 in FIG. 5; 708, 709, 710, 711 in FIG. 7) (e.g., operations associated with renderings performed in render-passes (e.g., 550 in FIG. 5; 750 in FIG. 7)). The set of render operations may include an individual bin load (e.g., 508 in FIG. 5; 708 in FIG. 7) to a graphics memory (e.g., 503 in FIG. 5; 703 in FIG. 7), that is separate from a system memory (e.g., 504 in in FIG. 5; 704 in FIG. 7), for the image data (e.g., 570 in FIG. 5; 670 in FIG. 6; 770 in FIG. 7) (e.g., in a respective bin of the subset of bins (e.g., 514, 518 in FIG. 5; 714, 718 in FIG. 7) such as the bin and the second bin (e.g., 514, 518 in FIG. 5; 714, 718 in FIG. 7)), a set of individual draws (e.g., at 509 in FIG. 5; at 709 in FIG. 7), an individual rendering (e.g., at 510 in FIG. 5; at 710 in FIG. 7), and/or an individual store (e.g., 511 in FIG. 5; 711 in FIG. 7) to the system memory (e.g., 504 in in FIG. 5; 704 in FIG. 7) for the image data (e.g., 570 in FIG. 5; 670 in FIG. 6; 770 in FIG. 7) (e.g., in the respective bin of the subset of bins such as for the bin and the second bin (e.g., 514, 518 in FIG. 5; 714, 718 in FIG. 7)). To determine to refrain from performing, for each bin in the subset of bins such as the bin and the second bin (e.g., 514, 518 in FIG. 5; 714, 718 in FIG. 7), the set of render operations (e.g., 508, 509, 510, 511 in FIG. 5; 708, 709, 710, 711 in FIG. 7), the graphics processor 804 may be configured to determine to refrain from performing the set of render operations (e.g., 508, 509, 510, 511 in FIG. 5; 708, 709, 710, 711 in FIG. 7) prior to the final render (e.g., of the portion of the image data (e.g., 570 in FIG. 5; 670 in FIG. 6; 770 in FIG. 7) as the combined render of the image data (e.g., 570 in FIG. 5; 670 in FIG. 6; 770 in FIG. 7)). To determine to refrain from performing (e.g., the set of render operations 508, 509, 510, 511 in FIG. 5; 708, 709, 710, 711 for each bin in the subset of bins, such as the bin and the second bin (e.g., 514, 518 in FIG. 5; 714, 718 in FIG. 7)) the graphics processor 804 may be configured to determine to refrain from performing the set of render operations (e.g., 508, 509, 510, 511 in FIG. 5; 708, 709, 710, 711 in FIG. 7) subsequent to a set of renders (e.g., at 710 for Bins 1, 3, 5, 6, 7, 8, 9 in FIG. 7), to the graphics memory (e.g., 503 in FIG. 5; 703 in FIG. 7), of a remaining portion of the image data (e.g., 570 in FIG. 5; 670 in FIG. 6; 770 in FIG. 7) associated with a remaining subset (e.g., 512, 516, 520, 522, 524, 526, 528 in FIG. 5; 712, 716, 720, 722, 724, 726, 728 in FIG. 7) of the set of bins (e.g., 507 in FIG. 5; 707 in FIG. 7), which excludes the subset of bins (e.g., 514, 518 in FIG. 5; 714, 718 in FIG. 7). For example, the graphics processor 804 may be configured to determine to refrain from performing (e.g., the set of render operations (e.g., 508, 509, 510, 511 in FIG. 5; 708, 709, 710, 711 in FIG. 7)) subsequent to at least one render (e.g., at 710 for Bins 1, 3, 5, 6, 7, 8, 9 in FIG. 7), to the graphics memory (e.g., 503 in FIG. 5; 703 in FIG. 7), of the image data (e.g., 570 in FIG. 5; 670 in FIG. 6; 770 in FIG. 7) respectively associated with at least one bin (e.g., 512, 516, 520, 522, 524, 526, 528 in FIG. 5; 712, 716, 720, 722, 724, 726, 728 in FIG. 7) of the set of bins (e.g., 507 in FIG. 5; 707 in FIG. 7), which may exclude the bin and the second bin (e.g., 514, 518 in FIG. 5; 714, 718 in FIG. 7). In aspects, the set of renders/the at least one render (e.g., at 710 for Bins 1, 3, 5, 6, 7, 8, 9 in FIG. 7) may be associated with respective indications of bin coverage (e.g., 580 in FIG. 5; 624, 626, 680 in FIG. 6; 766, 780 in FIG. 7) for remaining bins of the remaining subset (e.g., 512, 516, 520, 522, 524, 526, 528 in FIG. 5; 712, 716, 720, 722, 724, 726, 728 in FIG. 7) that meet the coverage threshold (e.g., 699 in FIG. 6), or may be associated with respective indications of bin coverage (e.g., 580 in FIG. 5; 624, 626, 680 in FIG. 6; 766, 780 in FIG. 7) for the at least one bin (e.g., 512, 516, 520, 522, 524, 526, 528 in FIG. 5; 712, 716, 720, 722, 724, 726, 728 in FIG. 7) that meets the coverage threshold (e.g., 699 in FIG. 6).

At 1008, the apparatus may render, to a graphics memory that is separate from a system memory, a remaining portion of the image data associated with a remaining/second portion of the image data associated with a remaining subset of the set of bins/a second bin or another bin, e.g., which may exclude the subset of bins/the bin, based on a determination that the indication of bin coverage for the second bin meets the coverage threshold (e.g., respective indications of bin coverage for remaining bins of the remaining subset that meet the coverage threshold). For example, referring to FIG. 8, the render (at 814) (e.g., at 510 in FIG. 5; at 710 in FIG. 7) may include to perform a set of remaining render operations (e.g., 508, 509, 510, 511 in FIG. 5; 708, 709, 710, 711 in FIG. 7). The performance of the set of remaining render operations (e.g., 508, 509, 510, 511 in FIG. 5; 708, 709, 710, 711 in FIG. 7) may include, for each remaining render operation in the set of remaining render operations (e.g., 508, 509, 510, 511 in FIG. 5; 708, 709, 710, 711 in FIG. 7)/for the second portion of the image data (e.g., 570 in FIG. 5; 670 in FIG. 6; 770 in FIG. 7): a load (e.g., 508 in FIG. 5; 708 in FIG. 7), to the graphics (e.g., 503 in FIG. 5; 703 in FIG. 7), of respective image data (e.g., 570 in FIG. 5; 670 in FIG. 6; 770 in FIG. 7) in a respective bin of the remaining subset (e.g., 512, 516, 520, 522, 524, 526, 528 in FIG. 5; 712, 716, 720, 722, 724, 726, 728 in FIG. 7)/the second portion of the image data (e.g., 570 in FIG. 5; 670 in FIG. 6; 770 in FIG. 7), an execution (e.g., at 509 in FIG. 5; at 709 in in FIG. 7), prior to the render (e.g., at 542 in FIG. 5; at 742 in FIG. 7), of a set of draw operations/a draw operation(s) associated with the respective bin of the subset of bins (e.g., 512, 516, 520, 522, 524, 526, 528 in FIG. 5; 712, 716, 720, 722, 724, 726, 728 in FIG. 7)/the second bin or the other bin to generate draw data, a render (e.g., 510 in FIG. 5; 710 in FIG. 7) of the remaining/second portion of the image data (e.g., 570 in FIG. 5; 670 in FIG. 6; 770 in FIG. 7), in association with or based on the generated draw data, e.g., as the set of remaining render operations (e.g., 508, 509, 510, 511 in FIG. 5; 708, 709, 710, 711 in FIG. 7) associated with respective bins of the remaining subset (e.g., 512, 516, 520, 522, 524, 526, 528 in FIG. 5; 712, 716, 720, 722, 724, 726, 728 in FIG. 7), a store (e.g., 511 in FIG. 5; 711 in FIG. 7), to the system memory (e.g., 504 in FIG. 5; 704 in FIG. 7), of the respective/rendered image data (e.g., 570 in FIG. 5; 670 in FIG. 6; 770 in FIG. 7) in the respective/second bin (e.g., of the remaining subset (e.g., 512, 516, 520, 522, 524, 526, 528 in FIG. 5; 712, 716, 720, 722, 724, 726, 728 in FIG. 7)), and/or the like. In some aspects, the render (at 814) (e.g., at 510 in FIG. 5; at 710 in FIG. 7) may include a render (e.g., at 510 in FIG. 5; at 710 in FIG. 7) of the remaining/second portion of the image data (e.g., 570 in FIG. 5; 670 in FIG. 6; 770 in FIG. 7) prior to the render (e.g., at 542 in FIG. 5; at 742 in FIG. 7), to the system memory (e.g., 504 in FIG. 5; 704 in FIG. 7), of the portion of the image data (e.g., 570 in FIG. 5; 670 in FIG. 6; 770 in FIG. 7).

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for determining, in a visibility-pass of image data for a set of bins, an indication of bin coverage for each bin in the set of bins. The apparatus may include means for rendering a portion of the image data associated with a bin in the set of bins based on the indication of bin coverage for the bin and the coverage threshold. The apparatus may further include means for rendering, in a render-pass and to a graphics memory that is separate from a system memory, a second portion of the image data associated with a second bin in the set of bins, based on a determination that the indication of bin coverage for the second bin meets the coverage threshold. The apparatus may further include means for obtaining the coverage threshold, where the coverage threshold is based on a configuration associated with a UMD or a KMD for a workload to which the image data corresponds.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of graphics processing, comprising: determining, in a visibility-pass of image data for a set of bins, an indication of bin coverage for each bin in the set of bins; and rendering a portion of the image data associated with a bin in the set of bins based on the indication of bin coverage for the bin and a coverage threshold.
Aspect 2 is the method of aspect 1, wherein rendering the portion of the image data includes: rendering, in a render-pass and to a system memory that is separate from a graphics memory, the portion of the image data based on a determination that the indication of bin coverage for the bin fails to meet the coverage threshold.
Aspect 3 is the method of aspect 2, wherein rendering the portion of the image data includes: executing, prior to the rendering, a draw operation associated with the bin to generate draw data for the rendering; determining to refrain from performing a load operation to the graphics memory for the portion of the image data associated with the bin; and determining to refrain from performing a store operation to the system memory for the portion of the image data associated with the bin.
Aspect 4 is the method of any of aspects 1 to 3, further comprising: rendering, in a render-pass and to a graphics memory that is separate from a system memory, a second portion of the image data associated with a second bin in the set of bins, based on a determination that the indication of bin coverage for the second bin meets the coverage threshold.
Aspect 5 is the method of aspect 4, wherein rendering, to the graphics memory, the second portion of the image data includes: loading, to the graphics memory, the second portion of the image data; executing, prior to the rendering, a draw operation associated with the second bin to generate draw data; rendering the second portion of the image data based on the draw data to generate rendered image data; and storing, to the system memory, the rendered image data in the second bin.
Aspect 6 is the method of aspect 4, wherein rendering, to the graphics memory, the second portion of the image data includes rendering the second portion of the image data prior to the rendering, to the system memory, of the portion of the image data.
Aspect 7 is the method of any of aspects 1 and 4 to 6, wherein rendering the portion of the image data includes: rendering, as a final rendering in a final render-pass, the portion of the image data.
Aspect 8 is the method of aspect 7, wherein rendering the portion of the image data includes: rendering, as a part of the final rendering in the final render-pass and combined with the portion of the image data, a second portion of the image data associated with a second bin in the set of bins based on the indication of bin coverage for the second bin and the coverage threshold.
Aspect 9 is the method of aspect 8, wherein rendering, as the part of the final rendering in the final render-pass and combined with the portion of the image data, the second portion of the image data includes: executing, prior to the final rendering, a total number of draw operations associated with the bin and the second bin to generate combined draw data; wherein the final rendering is based on the generated combined draw data.
Aspect 10 is the method of aspect 9, wherein the combined draw data comprises a combined visibility stream over the bin and the second bin; or wherein rendering, as the part of the final rendering in the final render-pass and combined with the portion of the image data, the second portion of the image data includes rendering based on a combined bin scissor operation.
Aspect 11 is the method of aspect 9, wherein rendering, as the part of the final rendering in the final render-pass and combined with the portion of the image data, the second portion of the image data includes determining to refrain from performing, for each of the bin and the second bin: an individual bin load to a graphics memory, that is separate from a system memory, for the image data; a set of individual draws; an individual rendering; and an individual store to the system memory for the image data.
Aspect 12 is the method of aspect 11, wherein determining to refrain from performing, for each of the bin and the second bin includes determining to refrain from performing prior to the final rendering.
Aspect 13 is the method of aspect 11, wherein determining to refrain from performing, for each of the bin and the second bin includes determining to refrain from performing subsequent to at least one rendering, to the graphics memory, of the image data respectively associated with at least one bin of the set of bins, which excludes the bin and the second bin, wherein the at least one rendering is associated with respective indications of bin coverage for the at least one bin that meets the coverage threshold.
Aspect 14 is the method of any of aspects 1 to 13, wherein determining the indication of bin coverage for each bin in the set of bins includes at least one of: calculating the bin coverage for each bin in the set of bins; or adjusting in a data structure, for each bin in the set of bins and based on the bin coverage for each bin, a respective indication of bin coverage that is associated with the coverage threshold.
Aspect 15 is the method of aspect 14, wherein calculating the bin coverage for each bin in the set of bins includes calculating, via a rasterizer, the bin coverage for each bin in the set of bins; wherein adjusting in the data structure, for each bin in the set of bins and based on the bin coverage for each bin, the respective indication of bin coverage includes adjusting in the data structure, via a command processor, the respective indication of bin coverage.
Aspect 16 is the method any of aspects 1 to 15, further comprising: obtaining the coverage threshold, wherein the coverage threshold is based on a configuration associated with a user-mode driver (UMD) or a kernel-mode driver (KMD) for a workload to which the image data corresponds.
Aspect 17 is the method any of aspects 1 to 16, wherein rendering the portion of the image data includes rendering, to a system memory, the portion of the image data, wherein the system memory is a video memory that is separate from a graphics memory dedicated to a graphics processing unit (GPU).
Aspect 18 is an apparatus for graphics processing comprising a processor coupled to a memory and, based on information stored in the memory, the processor is configured to implement a method as in any of aspects 1-17.
Aspect 19 may be combined with aspect 18 and comprises that the apparatus is a wireless communication device.
Aspect 20 is an apparatus for graphics processing comprising means for implementing a method as in any of aspects 1-17.
Aspect 21 is a computer-readable medium (e.g., a non-transitory computer readable-medium) storing computer executable code, the computer executable code, when executed by a processor, causes the processor to implement a method as in any of aspects 1-17.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
determine, in a visibility-pass of image data for a set of bins, an indication of bin coverage for each bin in the set of bins; and
render a portion of the image data associated with a bin in the set of bins based on the indication of bin coverage for the bin and a coverage threshold.

2. The apparatus of claim 1, wherein to render the portion of the image data, the processor is configured to:
render, in a render-pass and to a system memory that is separate from a graphics memory, the portion of the image data based on a determination that the indication of bin coverage for the bin fails to meet the coverage threshold.

3. The apparatus of claim 2, wherein to render the portion of the image data, the processor is configured to:
execute, prior to the render, a draw operation associated with the bin to generate draw data for the render;
determine to refrain from performing a load operation to the graphics memory for the portion of the image data associated with the bin; and
determine to refrain from performing a store operation to the system memory for the portion of the image data associated with the bin.

4. The apparatus of claim 1, wherein the processor is further configured to:
render, in a render-pass and to a graphics memory that is separate from a system memory, a second portion of the image data associated with a second bin in the set of bins, based on a determination that the indication of bin coverage for the second bin meets the coverage threshold.

5. The apparatus of claim 4, wherein to render, to the graphics memory, the second portion of the image data, the processor is configured to:
load, to the graphics memory, the second portion of the image data;
execute, prior to the render, a draw operation associated with the second bin to generate draw data;
render the second portion of the image data based on the draw data to generate rendered image data; and
store, to the system memory, the rendered image data in the second bin.

6. The apparatus of claim 4, wherein to render, to the graphics memory, the second portion of the image data, the processor is configured to render the second portion of the image data prior to the render, to the system memory, of the portion of the image data.

7. The apparatus of claim 1, wherein to render the portion of the image data, the processor is configured to:
render, as a final rendering in a final render-pass, the portion of the image data.

8. The apparatus of claim 7, wherein to render the portion of the image data, the processor is configured to:
render, as a part of the final render in the final render-pass and combined with the portion of the image data, a second portion of the image data associated with a second bin in the set of bins based on the indication of bin coverage for the second bin and the coverage threshold.

9. The apparatus of claim 8, wherein to render, as the part of the final render in the final render-pass and combined with the portion of the image data, the second portion of the image data, the processor is configured to:
execute, prior to the final render, a total number of draw operations associated with the bin and the second bin to generate combined draw data;
wherein the final render is based on the generated combined draw data.

10. The apparatus of claim 9, wherein the combined draw data comprises a combined visibility stream over the bin and the second bin; or
wherein to render, as the part of the final render in the final render-pass and combined with the portion of the image data, the second portion of the image data, the processor is configured to render based on a combined bin scissor operation.

11. The apparatus of claim 9, wherein to render, as the part of the final render in the final render-pass and combined with the portion of the image data, the second portion of the image data, the processor is configured to determine to refrain from performing, for each of the bin and the second bin:
an individual bin load to a graphics memory, that is separate from a system memory, for the image data;
a set of individual draws;
an individual rendering; and
an individual store to the system memory for the image data.

12. The apparatus of claim 11, wherein to determine to refrain from performing, for each of the bin and the second bin, the processor is configured to determine to refrain from performing prior to the final render.

13. The apparatus of claim 11, wherein to determine to refrain from performing, for each of the bin and the second bin, the processor is configured to determine to refrain from performing subsequent to at least one render, to the graphics memory, of the image data respectively associated with at least one bin of the set of bins, which excludes the bin and the second bin, wherein the at least one render is associated with respective indications of bin coverage for the at least one bin that meets the coverage threshold.

14. The apparatus of claim 1, wherein to determine the indication of bin coverage for each bin in the set of bins, the processor is configured to perform at least one of:
calculate the bin coverage for each bin in the set of bins; or
adjust in a data structure, for each bin in the set of bins and based on the bin coverage for each bin, a respective indication of bin coverage that is associated with the coverage threshold.

15. The apparatus of claim 14, wherein to calculate the bin coverage for each bin in the set of bins, the processor is configured to calculate, via a rasterizer, the bin coverage for each bin in the set of bins;
wherein to adjust in the data structure, for each bin in the set of bins and based on the bin coverage for each bin, the respective indication of bin coverage, the processor is configured to adjust in the data structure, via a command processor, the respective indication of bin coverage.

16. The apparatus of claim 1, wherein the processor is further configured to:
obtain the coverage threshold, wherein the coverage threshold is based on a configuration associated with a user-mode driver (UMD) or a kernel-mode driver (KMD) for a workload to which the image data corresponds.

17. The apparatus of claim 1, wherein to render the portion of the image data, the processor is configured to render, to a system memory, the portion of the image data, wherein the system memory is a video memory that is separate from a graphics memory dedicated to a graphics processing unit (GPU).

18. The apparatus of claim 1, wherein the apparatus is a wireless communication device.

19. A method of graphics processing, comprising:
determining, in a visibility-pass of image data for a set of bins, an indication of bin coverage for each bin in the set of bins; and
rendering a portion of the image data associated with a bin in the set of bins based on the indication of bin coverage for the bin and a coverage threshold.

20. A computer-readable medium storing computer executable code, the computer executable code, when executed by a processor, causes the processor to:
determine, in a visibility-pass of image data for a set of bins, an indication of bin coverage for each bin in the set of bins; and
render a portion of the image data associated with a bin in the set of bins based on the indication of bin coverage for the bin and a coverage threshold.
